(19) United States
(12) Patent Application Publication
(10) Pub. No.: US 2025/0064029 A1
(43) Pub. Date: Feb. 27, 2025

(54) DEVICE AND METHOD FOR NITROGEN AND PHOSPHORUS REMOVAL FROM AQUACULTURE TAIL WATER BASED ON AGRICULTURAL WASTE FILLER

(71) Applicant: Pearl River Fisheries Research Institute, Chinese Academy of Fishery Sciences, Guangzhou (CN)

(72) Inventors: Wangbao GONG, Guangzhou (CN); Jun XIE, Guangzhou (CN); Guangjun WANG, Guangzhou (CN); Zhifei LI, Guangzhou (CN); Kai ZHANG, Guangzhou (CN); Zhilong WANG, Guangzhou (CN); Yun XIA, Guangzhou (CN); Hongyan LI, Guangzhou (CN); Jingjing TIAN, Guangzhou (CN); Wenping XIE, Guangzhou (CN)

(21) Appl. No.: 18/791,827

(22) Filed: Aug. 1, 2024

(30) Foreign Application Priority Data
Aug. 25, 2023 (CN) 202311077094.8

(51) Int. Cl. A01K 63/04; C02F 1/58; C02F 101/10; C02F 101/16; C02F 103/20

(52) U.S. Cl. CPC A01K 63/04; C02F 1/58; C02F 2101/105; C02F 2101/16; C02F 2103/20

(57) ABSTRACT

Disclosed are a device and a method for nitrogen and phosphorus removal from aquaculture tail water based on agricultural waste filler, and belongs to the technical field of aquaculture tail water treatment. The device includes a device main body, and a reaction part is arranged in the device main body; a bottom end of the device main body is communicated with an aquaculture tail water storage pool, and a top side wall of the device main body is communicated with an effluent collection pool; and the reaction part comprises agricultural waste filler and denitrifying sludge contained in the device main body, and the agricultural waste filler and the denitrifying sludge are soaked in the aquaculture tail water.

### CROSS-REFERENCE TO RELATED APPLICATIONS

The disclosure claims priority to Chinese Patent Application No. 202311077094.8, filed on Aug. 25, 2023, the contents of which are hereby incorporated by reference.

### TECHNICAL FIELD

The disclosure belongs to the technical field of aquaculture tail water treatment, and particularly relates to a device and a method for nitrogen and phosphorus removal from aquaculture tail water based on agricultural waste filler.

### BACKGROUND

The aquaculture tail water is the main pollution source of aquaculture. During the aquaculture process, a large amount of feed input and the production of fish excrement lead to the accumulation of nitrogen and phosphorus pollutants such as nitrate in aquaculture water, which may not only cause the deterioration of aquaculture water quality and frequent diseases of aquaculture animals, but also affect the quality of aquatic products. Moreover, if discharged directly without treatment, the aquaculture tail water may damage the surrounding ecological environment and endanger human health at the same time. Therefore, the aquaculture tail water needs to be treated for nitrogen and phosphorus removal before discharge.

At present, heterotrophs denitrification method is considered as one of the economic and environmental protection methods to remove NO₃⁻—N from water. The main principle is that denitrifying microorganisms take NO₃⁻—N as the terminal electron acceptor, and organic matter or inorganic matter as the electron donor and energy source for denitrification, and the final product is nitrogen (N₂). Theoretically, it takes 2.86 grams (g) COD (C/N=2.86) to denitrify 1 g NO₃⁻—N into N₂, but in practical production, it usually needs a higher C/N. However, there are usually some problems such as low C/N ratio and incomplete denitrification in aquaculture tail water, so sufficient organic carbon is the key to obtain efficient removal of NO₃⁻—N.

Agricultural waste filler is a product obtained from agriculture, and may be used to make feed or fertilizer. However, these two methods have limited digestibility and produce a large amount of agricultural waste filler residue, causing a lot of waste and also polluting the environment. Agricultural waste also contains a lot of cellulose, hemicellulose and lignin, which may be decomposed and utilized by microorganisms and may be used as an additional carbon source for sewage treatment.

Therefore, the disclosure designs a device and a method for nitrogen and phosphorus removal from aquaculture tail water based on agricultural waste filler to solve the above problems.

### SUMMARY

In order to solve the above technical problems, the disclosure provides a device and a method for nitrogen and phosphorus removal from aquaculture tail water based on agricultural waste filler.

In order to achieve the above objective, the disclosure provides a device for nitrogen and phosphorus removal from aquaculture tail water based on agricultural waste filler, including a device main body, and a reaction part is arranged in the device main body;
a bottom end of the device main body is communicated with an aquaculture tail water storage pool, and a top side wall of the device main body is communicated with an effluent collection pool; and
the reaction part includes agricultural waste filler and denitrifying sludge contained in the device main body.

Optionally, a bottom end of a side wall of the device main body is provided with a water inlet, where the water inlet is communicated with the aquaculture tail water storage pool through a constant-current peristaltic pump; and a top end of the side wall of the device main body is provided with a water outlet, and the water outlet is communicated with the effluent collection pool.

Optionally, a porous supporting plate is fixedly connected in the device main body, the agricultural waste filler is piled on the supporting plate, and the denitrifying sludge is piled on the agricultural waste filler.

Optionally, an installation position of the supporting plate is higher than a position of the water inlet.

Optionally, the device main body is filled with quartz sand filler, and the quartz sand filler is filled with mixture filler including the agricultural waste filler, the denitrifying sludge and the quartz sand filler.

Optionally, a top end of the quartz sand filler is located above the water outlet, and a bottom end of the quartz sand filler is located below the water inlet; and the mixture filler is located between the water inlet and the water outlet.

A method for nitrogen and phosphorus removal from aquaculture tail water based on agricultural waste filler includes following steps:
S1, connecting the aquaculture tail water storage pool and the effluent collection pool;
S2, filling the agricultural waste filler and the denitrifying sludge of the reaction part;
S3, introducing the aquaculture tail water into the device main body, where the aquaculture tail water overflows the reaction part;
S4, setting appropriate reaction conditions to make the aquaculture tail water stay in the device main body for a period of time;
S5, upon reaching the time, introducing the aquaculture tail water into the device main body again, and causing reacted aquaculture tail water to overflow and be discharged into the effluent collection pool; and
S6, repeating a process of introducing, reacting, overflowing and discharging of the aquaculture tail water.

Optionally, during reaction, a reaction temperature is 20±2 degrees Celsius (° C.), a light intensity is 355±31 Lux, dissolved oxygen (DO) is not higher than 1 milligram per litre (mg/L), and pH is weak acid or neutral.

Optionally, a reaction residence time of the aquaculture tail water in the device main body is 30-35 hours (h).

Compared with the prior art, the disclosure has the following advantages and technical effects. Aiming at aquaculture tail water rich in nitrogen and phosphorus pollutants, the disclosure establishes a device and a treatment method for nitrogen and phosphorus removal from aquaculture tail water based on agricultural waste filler by adding agricultural waste filler and denitrifying sludge into the device main body, fully reacting the nitrogen and phosphorus pollutants with denitrifying sludge, and using the agricultural waste filler as a carbon source, thus achieving better purification effect of aquaculture tail water. On the one hand, the microbial treatment efficiency is improved, and the nitrogen and phosphorus pollutants in aquaculture tail water are reduced, with low energy consumption, good effect and no secondary pollution. On the other hand the rational use of agricultural waste filler, which is characterized by easy availability of materials, low cost, low biotoxicity and continuous carbon release, reduces the waste of agricultural waste filler. Nitrogen and phosphorus pollutants in aquaculture tail water are absorbed by microorganisms in denitrifying sludge, which has good removal effect and will not produce additional pollutants. Introducing agricultural waste filler to supplement the carbon source in the reaction may not only effectively remove nitrogen and phosphorus pollutants, but also purify the water quality, and may also use the reacted agricultural waste filler as fertilizer or other uses, generating additional economic benefits.

According to the disclosure, the denitrifying sludge and the agricultural waste filler are combined, so that the aquaculture tail water treatment effect is good, the operation cost is low, the occupied area is relatively small, and the method has great economic benefits and market application prospects.

### BRIEF DESCRIPTION OF THE DRAWINGS

The attached drawings, which constitute a part of the disclosure, are used to provide a further understanding of the disclosure. The illustrative embodiments of the disclosure and their descriptions are used to explain the disclosure, and do not constitute an improper limitation of the disclosure. In the attached drawings:

FIG. 1 is a schematic structural diagram of a device according to embodiment 1 of the disclosure.

FIG. 2 is a schematic structural diagram of a device according to embodiment 2 of the disclosure.

FIG. 3 is a flow chart of a method according to the disclosure.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiment of the disclosure, but not the whole embodiment. Based on the embodiments in the disclosure, all other embodiments obtained by ordinary technicians in the field without creative labor belong to the scope of protection of the disclosure.

In order to make the above objects, features and advantages of the disclosure more obvious and easy to understand, the disclosure will be further described in detail with the attached drawings and specific embodiments.

### Embodiment 1

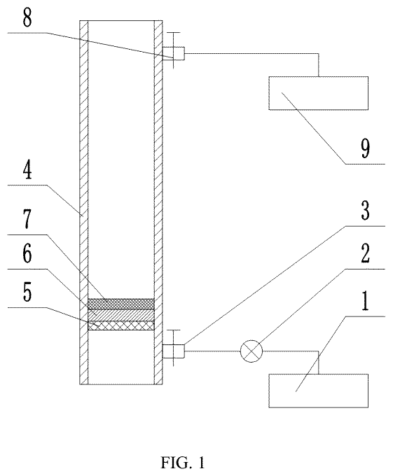

With reference to FIG. 1, this embodiment provides a device for nitrogen and phosphorus removal from aquaculture tail water based on agricultural waste filler, including a device main body 4, and a reaction part is arranged in the device main body 4;
a bottom end of the device main body 4 is communicated with an aquaculture tail water storage pool 1, and a top side wall of the device main body 4 is communicated with an effluent collection pool 9; and
the reaction part includes agricultural waste filler 6 and denitrifying sludge 7 contained in the device main body 4.

Aiming at aquaculture tail water rich in nitrogen and phosphorus pollutants, the disclosure establishes a device and a treatment method for nitrogen and phosphorus removal from aquaculture tail water based on the agricultural waste filler 6 by adding the agricultural waste filler 6 and the denitrifying sludge 7 into the device main body 4, fully reacting the nitrogen and phosphorus pollutants with denitrifying sludge, and using the agricultural waste filler 6 as a carbon source, thus achieving better purification effect of aquaculture tail water. On the one hand, the microbial treatment efficiency is improved, and the nitrogen and phosphorus pollutants in aquaculture tail water are reduced, with low energy consumption, good effect and no secondary pollution. On the other hand the rational use of agricultural waste filler 6, which is characterized by easy availability of materials, low cost, low biotoxicity and continuous carbon release, reduces the waste of agricultural waste filler 6. Nitrogen and phosphorus pollutants in the aquaculture tail water are absorbed by microorganisms in denitrifying sludge 7, which has good removal effect and will not produce additional pollutants. Introducing the agricultural waste filler 6 to supplement the carbon source in the reaction may not only effectively remove nitrogen and phosphorus pollutants, but also purify the water quality, and may also use the reacted agricultural waste filler 6 as fertilizer or other uses, generating additional economic benefits.

In an embodiment, the device main body 4 of this embodiment is preferably made of transparent material, such as plexiglass, which is convenient for providing sufficient illumination during the reaction and also convenient for users to observe the progress of the reaction.

In an embodiment, the device main body 4 has a diameter of 10 centimeters (cm) and a height of 55 cm.

In an embodiment, a bottom end of a side wall of the device main body 4 is provided with a water inlet 3, where the water inlet 3 is communicated with the aquaculture tail water storage pool 1 through a constant-current peristaltic pump 2; a top end of the side wall of the device main body 4 is provided with a water outlet 8, and the water outlet 8 is communicated with the effluent collection pool 9.

The aquaculture tail water in the aquaculture tail water storage pool 1 is pumped into the device main body 4 from the water inlet 3 at a constant speed through the constant-current peristaltic pump 2, and the reacted aquaculture tail water flows out of the device main body 4 from the water outlet 8 at a top end and enters the effluent collection pool 9, thus completing the treatment process of the aquaculture tail water.

In an embodiment, the water inlet 3 is located 5 cm upward from a bottom of the device main body 4, and the water outlet 8 is located 5 cm downward from a top of the device main body 4.

In an embodiment, a porous supporting plate 5 is fixedly connected in the device main body 4, the agricultural waste filler 6 is piled on the supporting plate 5, and the denitrifying sludge 7 is piled on the agricultural waste filler 6. The agricultural waste filler 6 and denitrifying sludge 7 are laid on the supporting plate 5 in turn from bottom to top to prevent falling; the aquaculture tail water entering the device main body 4 overflows the reaction part from the bottom, the microorganisms in the denitrifying sludge 7 treat nitrogen and phosphorus pollutants in the aquaculture tail water, and the agricultural waste filler 6 is used as a carbon source to supplement the reaction of microorganisms, thus improving the reaction efficiency and accelerating the sewage treatment speed.

In an embodiment, the agricultural waste filler 6 of this embodiment is sorghum straw.

In an embodiment, the addition amount of the agricultural waste filler 6 is not less than 40 g.

In an embodiment, the addition amount of the denitrifying sludge 7 is not less than 200 millilitre (ml).

In an embodiment, an installation position of the supporting plate 5 is higher than a position of the water inlet 3. The supporting plate 5 is located above the water inlet 3, so that the aquaculture tail water entering the device main body 4 overflows from the bottom of the supporting plate 5, and the agricultural waste filler 6 and denitrifying sludge 7 are ensured to be piled up in the aquaculture tail water.

In an embodiment, the hydraulic retention time of this embodiment is set to 32 h and is controlled by the constant-current peristaltic pump 2.

In an embodiment, the aquaculture tail water of this embodiment is synthetic aquaculture tail water, and an influent nitrate concentration (INC) is 50 mg/L.

### Embodiment 2

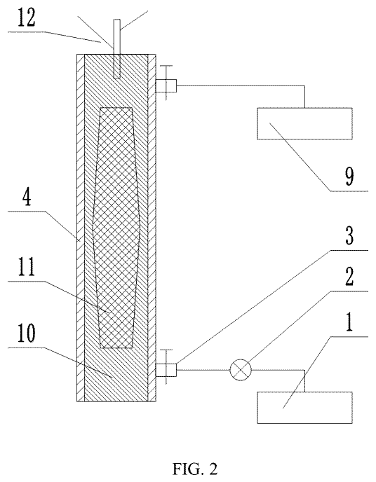

With reference to FIG. 2, the device main body 4 is filled with quartz sand filler 10, and the quartz sand filler 10 is filled with mixture filler 11 including the agricultural waste filler 6, the denitrifying sludge 7 and the quartz sand filler 10. The quartz sand filler 10 replaces the supporting plate 5 to fix the reaction part, and the quartz sand filler 10 may also play a certain filtering role to prevent the particulate pollutants in the aquaculture sewage from gathering in the device main body 4; the quartz sand filler 10 fills the inner cavity of the device main body 4, and the mixture including quartz sand filler, denitrifying sludge 7 and agricultural waste filler 6 is filled in the center of the quartz sand filler 10. The mixture filler 11 is wrapped and fixed by the quartz sand filler 10 to prevent the mixture filler 11 from being washed away by aquaculture tail water. At the same time, the mixture of denitrifying sludge 7, agricultural waste filler 6 and quartz sand filler 10 increases the contact area between aquaculture tail water and the mixture filler 11, making the reaction more complete and rapid.

In an embodiment, green plants 12 are planted at a top end of quartz sand filler 10, and the treatment state of aquaculture tail water is observed through the growth status of green plants 12. In this embodiment, disease-free Cyperus involucratus Rottboll is selected as the green plant 12.

In an embodiment, the top end of the quartz sand filler 10 is located above the water outlet 8, and a bottom end of the quartz sand filler 10 is located below the water inlet 3; the mixture filler 11 is located between the water inlet 3 and the water outlet 8.

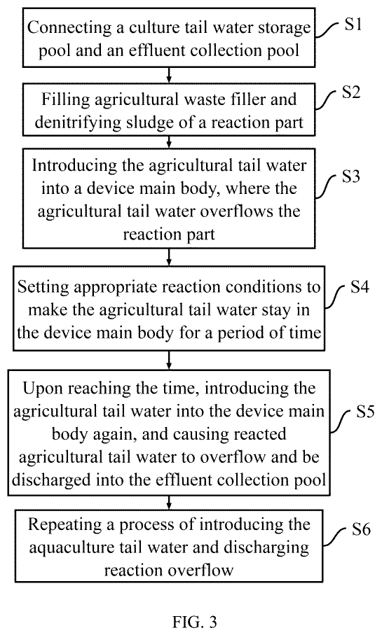

A method for nitrogen and phosphorus removal from aquaculture tail water based on agricultural waste filler, as shown in FIG. 3, including the following steps:
S1, connecting the aquaculture tail water storage pool 1 and the effluent collection pool 9; connecting the device main body 4 with the aquaculture tail water storage pool 1 and the effluent collection pool 9, and installing the constant-current peristaltic pump 2 between the aquaculture tail water storage pool 1 and the device main body 4 to complete the installation of the treatment device;
S2, filling the agricultural waste filler 6 and the denitrifying sludge 7 of the reaction part; according to the actual situation, selecting two different filling methods, and then putting the agricultural waste filler 6 and the denitrifying sludge 7 in the device main body 4 to prepare for the treatment of aquaculture tail water;
S3, introducing the aquaculture tail water into the device main body 4, where the aquaculture tail water overflows the reaction part; introducing the aquaculture tail water into the device main body 4 through the constant-current peristaltic pump 2, where the device tail water overflows the denitrifying sludge 7 and agricultural wastes but does not flow out from the water outlet 8;
S4, setting appropriate reaction conditions to make the aquaculture tail water stay in the device main body 4 for a period of time; setting appropriate reaction conditions to make the aquaculture tail water react in the device main body 4 to treat nitrogen and phosphorus pollutants in the aquaculture tail water; during reaction, a reaction temperature is 20±2° C., a light intensity is 355±31 Lux, dissolved oxygen DO is not higher than 1 mg/L, and pH is weak acid or neutral;
S5, upon reaching the time, introducing the aquaculture tail water into the device main body 4 again, causing the reacted aquaculture tail water to overflow and be discharged into the effluent collection pool 9; after reaching a reaction time, pumping the aquaculture tail water into the device main body 4 again through the constant-current peristaltic pump 2, and discharging the reacted aquaculture tail water from a mouth to the collection pool to complete the treatment, and then storing the newly filled aquaculture tail water for a set time to be treated again; and
S6, repeating a process of introducing, reacting, overflowing and discharging of the aquaculture tail water.

In an embodiment, a reaction residence time of the aquaculture tail water in the device main body 4 is 30-35 h. In the embodiment, the reaction time in the device main body 4 of the aquaculture tail water during use is selected as 32 h.

### Specific Embodiment 1

With reference to the treatment device and the treatment method in Embodiment 1, the results show that the nitrogen and phosphorus removal device may completely remove NH₄⁺—N, and the NO₃⁻—N removal rate is about 95.71%. A reactor may achieve a good removal effect of NO₃⁻—N, and meanwhile, NO₂⁻—N may be reduced below 1 mg/L, so complete denitrification may be realized. The total nitrogen TN removal rate is about 93.46%, and the total phosphorus TP removal rate is about 87.01%.

### Specific Embodiment 2

The treatment process of this specific embodiment is different from that of the first specific embodiment only in that the hydraulic residence time of the nitrogen and phosphorus removal device is set to 36 h. The results show that the nitrogen and phosphorus removal device may completely remove NH₄⁺—N. The corresponding NO₃⁻—N removal rate is about 98.50%, and the reactor may achieve a good NO₃⁻—N removal effect, while NO₂⁻—N is below 0.5 mg/L, and complete denitrification may be achieved. The total nitrogen TN removal rate is about 94.93%. The total phosphorus TP removal rate is about 87.93%.

### Specific Embodiment 3

The treatment process of this specific embodiment is different from that of the first specific embodiment only in that the influent nitrate concentration of synthetic aquaculture tail water is set to 75 mg/L. The results show that the nitrogen and phosphorus removal device may completely remove NH₄⁺—N. The corresponding NO₃⁻—N removal rate is about 93.58%, and the reactor may achieve a good NO₃⁻—N removal effect, while the NO₂⁻—N accumulation is 2.07 mg/L, failing to achieve complete denitrification. The total nitrogen TN removal rate is about 77.54%. The total phosphorus TP removal rate is about 82.05%.

### Specific Embodiment 4

The treatment process of this specific embodiment is different from that of the first specific embodiment only in that the influent nitrate concentration of synthetic aquaculture tail water is set to 100 mg/L. The results show that the nitrogen and phosphorus removal device may completely remove NH₄⁺—N. The corresponding NO₃⁻—N removal rate is about 94.36%, and the reactor may achieve a good NO₃⁻—N removal effect, while the NO₂⁻—N accumulation is 2.81 mg/L, failing to achieve complete denitrification. The total nitrogen TN removal rate is about 83.00%. The total phosphorus TP removal rate is about 82.16%.

### Specific Embodiment 5

With reference to FIG. 2 and the Embodiment 2, the treatment process of aquaculture tail water is the same as above. The results show that the nitrogen and phosphorus removal device may completely remove NH₄⁺—N. The corresponding NO₃⁻—N removal rate is about 67.75%, and the reactor may achieve a good NO₃⁻—N removal effect, while NO₂⁻—N is reduced below 1 mg/L, and complete denitrification may be achieved. The total nitrogen TN removal rate is about 61.18%. The total phosphorus TP removal rate is about 73.41%.

### Specific Embodiment 6

The treatment process of this specific embodiment is different from that of the specific embodiment 5 only in that the operating temperature of the device is 10±0.40° C. The nitrogen and phosphorus removal device may almost completely remove NH₄⁺—N, and the corresponding NO₃⁻—N removal rate is about 28.56%, while NO₂⁻—N is reduced below 1 mg/L, realizing complete denitrification. The total nitrogen TN removal rate is about 9.41%. The total phosphorus TP removal rate is about 68.29%.

### Specific Embodiment 7

The treatment process of this specific embodiment is different from that of the fifth specific embodiment only in that the operating temperature of the device is 30±0.70° C. The nitrogen and phosphorus removal device may almost completely remove NH₄⁺—N. The corresponding NO₃⁻—N removal rate is about 73.77%, and the reactor may achieve a good NO₃⁻—N removal effect, while the NO₂⁻—N accumulation is 1.16 mg/L, failing to achieve complete denitrification. The total nitrogen TN removal rate is about 69.85%. The total phosphorus TP removal rate is about 72.63%.

In the description of the disclosure, it should be understood that terms “longitudinal”, “transverse”, “up”, “down”, “front”, “back”, “left”, “right”, “vertical”, “horizontal”, “top”, “bottom”, “inside”, “outside” and other directional or positional relationships indicated are based on the directional or positional relationships shown in the accompanying drawings, only for the convenience of describing the disclosure, and do not indicate or imply that the device or element referred to must have a specific orientation, be constructed and operated in a specific orientation, and therefore may not be understood as a limitation of the disclosure.

The above-mentioned embodiments only describe the preferred mode of the disclosure, and do not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. A device for nitrogen and phosphorus removal from aquaculture tail water based on agricultural waste filler, comprising a device main body, and a reaction part is arranged in the device main body;
a bottom end of the device main body is communicated with an aquaculture tail water storage pool, and a top side wall of the device main body is communicated with an effluent collection pool; and
the reaction part comprises agricultural waste filler and denitrifying sludge contained in the device main body.

2. The device for the nitrogen and phosphorus removal from the aquaculture tail water based on the agricultural waste filler according to claim 1, wherein a bottom end of a side wall of the device main body is provided with a water inlet, wherein the water inlet is communicated with the aquaculture tail water storage pool through a constant-current peristaltic pump; and a top end of the side wall of the device main body is provided with a water outlet, and the water outlet is communicated with the effluent collection pool.

3. The device for the nitrogen and phosphorus removal from the aquaculture tail water based on the agricultural waste filler according to claim 2, wherein a porous supporting plate is fixedly connected in the device main body, the agricultural waste filler is piled on the supporting plate, and the denitrifying sludge is piled on the agricultural waste filler.

4. The device for the nitrogen and phosphorus removal from the aquaculture tail water based on the agricultural waste filler according to claim 3, wherein an installation position of the supporting plate is higher than a position of the water inlet.

5. The device for the nitrogen and phosphorus removal from the aquaculture tail water based on the agricultural waste filler according to claim 2, wherein the device main body is filled with quartz sand filler, and the quartz sand filler is filled with mixture filler comprising the agricultural waste filler, the denitrifying sludge and the quartz sand filler.

6. The device for the nitrogen and phosphorus removal from the aquaculture tail water based on the agricultural waste filler according to claim 5, wherein a top end of the quartz sand filler is located above the water outlet, and a bottom end of the quartz sand filler is located below the water inlet; and the mixture filler is located between the water inlet and the water outlet.

7. A method for nitrogen and phosphorus removal from aquaculture tail water based on agricultural waste filler, according to the device for the nitrogen and phosphorus removal from the aquaculture tail water based on the agricultural waste filler according to claim 1, comprising following steps:
S1, connecting the aquaculture tail water storage pool and the effluent collection pool;
S2, filling the agricultural waste filler and the denitrifying sludge of the reaction part;
S3, introducing the aquaculture tail water into the device main body, wherein the aquaculture tail water overflows the reaction part;
S4, setting appropriate reaction conditions to make the aquaculture tail water stay in the device main body for a period of time;
S5, upon reaching the time, introducing the aquaculture tail water into the device main body again, and causing reacted aquaculture tail water to overflow and be discharged into the effluent collection pool; and
S6, repeating a process of introducing, reacting, overflowing and discharging of the aquaculture tail water.

8. The method for the nitrogen and phosphorus removal from the aquaculture tail water based on the agricultural waste filler according to claim 7, wherein during reaction, a reaction temperature is 20±2° C., a light intensity is 355±31 Lux, DO is not higher than 1 mg/L, and pH is weak acid or neutral.

9. The method for the nitrogen and phosphorus removal from the aquaculture tail water based on the agricultural waste filler according to claim 7, wherein a reaction residence time of the aquaculture tail water in the device main body is 30-35 h.
